(19) United States
(12) Patent Application Publication
(10) Pub. No.: US 2015/0122158 A1
(43) Pub. Date: May 7, 2015

(54) TRAY DEVICE IN A SPORTS ACTION POSE

(71) Applicant: Basement Dad Sports, San Clemente, CA (US)

(72) Inventors: Kenneth L. St. Cyr, San Clemente, CA (US); Catherine D. St. Cyr, San Clemente, CA (US); Peter Michaelian, San Francisco, CA (US); Lucas Saule, San Francisco, CA (US)

(73) Assignee: Basement Dad Sports, San Clemente, CA (US)

(21) Appl. No.: 14/160,431

(22) Filed: Jan. 21, 2014

Related U.S. Application Data
(60) Provisional application No. 61/900,201, filed on Nov. 5, 2013.

(51) Int. Cl. A47B 7/00; F16M 11/22; A47B 13/10; A47B 3/06; A47B 13/02; F16M 11/02; A47B 3/00

(52) U.S. Cl. CPC A47B 7/00; F16M 11/02; F16M 11/22; A47B 3/00; A47B 3/06; A47B 13/02; A47B 13/10
USPC 108/25; 108/161; 108/157.1; 108/115

(57) ABSTRACT

The present invention provides a tray device in a sports action pose. The device includes a body, a tray, and a base. The body includes a front, a back, and a head. The device's sports action pose contributes to a more stable tray than conventional trays, which is beneficial when multiple objects are unevenly placed on the tray or when the tray is bumped. In additional to a food/beverage tray, the device may also include a cup holder, which is especially useful for tailgating parties. The tray can be disassembled or folded which makes it easier to transport and store the device.

### CROSS REFERENCE TO RELATED APPLICATIONS

This application claims priority under 35 U.S.C. §119(e) to U.S. Provisional Application No. 61/900,201, filed Nov. 5, 2013, and entitled “Tray device in a sports action pose,” the disclosure of which is hereby incorporated by reference in its entirety.

### BACKGROUND OF THE INVENTION

1. Field of Invention

The present invention relates to food and/or beverage trays, and more specifically, to a food and/or beverage tray comprising a sports figure in action holding a tray.

2. Description of Related Art

A tray is a platform configured to hold or carry things. Trays are most commonly known for carrying food and beverages, although technically can be used for storage, organizing, and carrying non-food/beverage objects such as mail, plants, and medical devices. A tray typically has raised edges and/or an anti-slip material to stop objects from sliding off the tray. Exemplary types of trays include a butler's tray, a cafeteria tray, a surgical tray, a seed tray, a darkroom tray, and a dental tray.

An issue with conventional trays is the stability of the tray. Typically, the tray will have an object, such as a glass full of liquid, that should not fall regardless whether the tray is stationary, being moved, bumped, loaded unevenly, etc.

Another issue with conventional trays is the mobility of the tray. A heavier tray may or may not be more stable, but it is more difficult to move such as through shipping or in the trunk of a user's car, which is critical if the tray is supposed to travel over large distances.

A further issue with conventional trays is the storage of the tray. If the tray is configured to carry objects from one location to another, then the tray will typically be stored away when not in use and storage size is important. Alternatively, if the tray is mostly configured to be used in a stationary position, where the tray functions as an organizer, the size of the tray is more dependent on the practical application and cosmetic concerns than storage.

FIG. 1 illustrates a conventional butler device 100 which is known in the prior art. The device 100 includes a base 105, a body 110, a tray 115, and one or more objects 120. The device 100 (e.g., figurine, tray holder, statute, etc.) resembles a butler holding the tray 115, and the tray 115 is configured to hold one or more objects 120, such as bottle of wine.

The base 105 provides some stability such that the objects 120 do not tip over the device 100. The base 105 is typically limited in size for mobility and aesthetic reasons. The body 110 provides the proper height for the tray 115 and provides aesthetics for the device 100. The device 100 is often very small, as the term figurine implies, though can also stand 2-3 feet tall. Although a butler is illustrated, and is a very common theme, other themes exist. Other themes include a maid, a chef, a holiday character, and an animal such as a Dalmatian. Most themes are related somehow to food.

The tray 115 is a conventional tray. Conventional trays often have an outer lip to prevent the objects 120 from sliding off the tray 115. The objects 120 include one or more small items, typically related to the butler theme, such as a bottle or glass of wine. The objects are limited in size by the size of the tray 115 and the stability of the base 105 and body 110.

However, the conventional devices fall short because they still contain issues regarding stability, mobility, and storage. Specifically, the conventional devices are typically not balanced well, such that if a user puts too much uneven weight on the tray, the tray will tilt the device over. This is partly due to the location and pose of the device's body on the base and the device's leg and hand positions not being configured for a good balance. Regarding mobility, the devices are configured as a small single structure and are not intended for regular transport. Regarding storage, the devices are mostly configured either small or for stationary use, such that putting a large tray in the trunk of the user's car is not an issue of concern.

### SUMMARY OF THE INVENTION

The present invention provides a tray device in a sports action pose. The device includes a body, a tray, and a base. The body includes a front, a back, and a head. The device's sports action pose contributes to a more stable tray than conventional trays, which is beneficial when multiple objects are unevenly placed on the tray or when the tray is bumped. In additional to a food/beverage tray, the device may also include a cup holder, which is especially useful for tailgating parties. The tray can be disassembled or folded which makes it easier to transport and store the device.

In one embodiment, a device comprises: a body, wherein the body is configured in a sports action pose, wherein the sports action pose comprises an action relating to a sport; a tray attached to the body, wherein the tray is configured to hold objects; and a base attached to the body, wherein the base and the sports action pose of the body are configured to provide stability to the body.

In another embodiment, a device comprises: a body, wherein the body is configured in a sports action pose, wherein the sports action pose comprises an action relating to a sport; wherein the body is configured to attach to a tray, wherein the tray is configured to hold objects; and wherein the body is configured to attach to a base, wherein the base and the sports action pose of the body are configured to provide stability to the body.

An advantage is that the device is more stable and thus harder to knock over. The increased stability is due to the base and the body, where the body is in a sports action pose. Many sports action poses are inherently stable, as stability is a key factor to success in many sports. For example, in football, stability helps the players remain on their feet or perform an action better. Often times this stability is referred to in the sports world by other terms, such as a strong base or good balance. The stability lessens the chances that the tray will be knocked over when loaded with too many objects, when loaded unevenly, or when bumped into. The cup holder combined with the tray provides an additional advantage, as the cup holder's high walls significantly lessen the chances that a drink will spill.

Another advantage is that the device is more mobile due to the disassembly, folding, and/or basically flat body structural features. The mobility can lead to easier shipping to the user and easier fitting into the trunk of the user's car. Thus, the device is ideal for tailgating, unlike conventional devices. Additionally, by having a tray together with a cup holder, the device is ideal for a watching a sport event, typically accompanied by both food and beverages. For similar reasons to the increased mobility, a further advantage is that the device is easier to store.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows:

FIG. 1 illustrates a conventional butler which is known in the prior art;

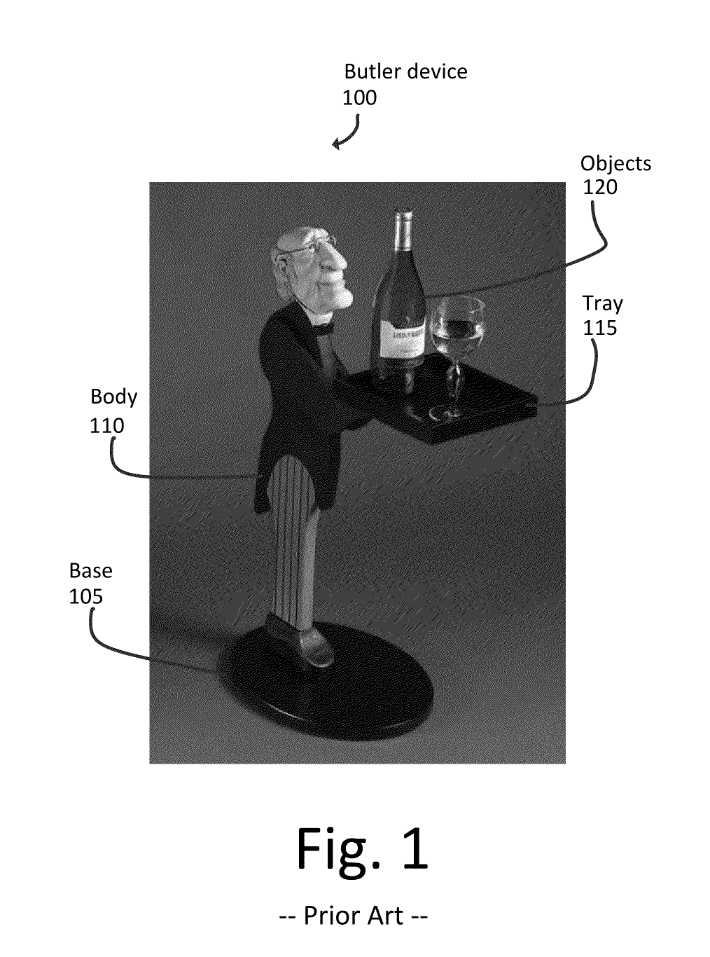

FIG. 2 illustrates a device according to an embodiment of the invention;

FIG. 3 illustrates the device in use holding one or more objects according to an embodiment of the invention;

FIG. 4 illustrates a close-up of a tray of the device according to an embodiment of the invention;

FIG. 5 illustrates a close-up of a cup holder of the device and optional assembly features according to an embodiment of the invention;

FIGS. 6-8 illustrate devices with optional folding features according to embodiments of the invention; and

FIG. 9 illustrates a process of using the device according to an embodiment of the invention.

### DETAILED DESCRIPTION OF EMBODIMENTS

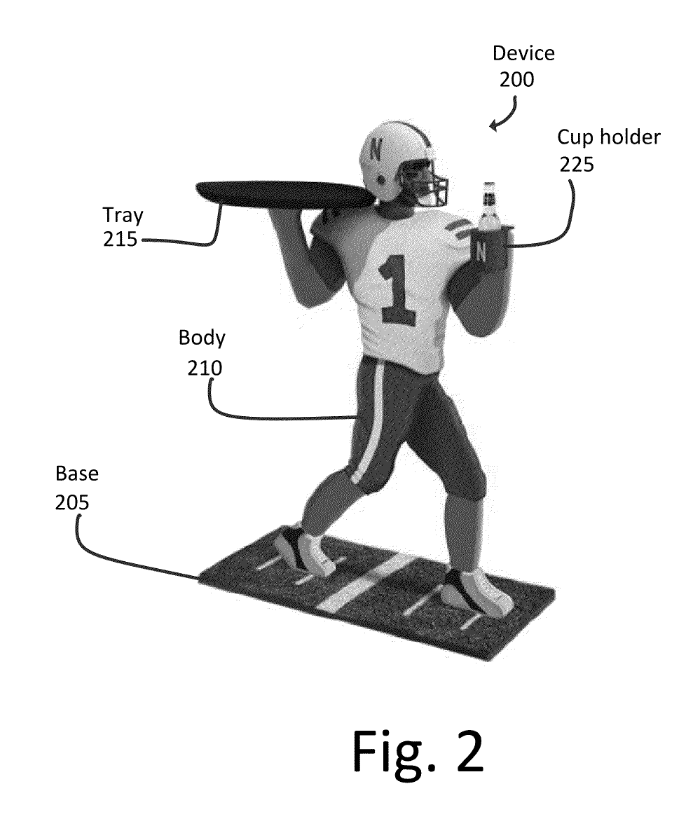

Further features and advantages of the invention, as well as the structure and operation of various embodiments of the invention, are described in detail below with reference to the accompanying FIGS. 2-9, wherein like reference numerals refer to like elements.

Although the present invention is illustrated and described as having the objects on the tray being food and beverages, one of ordinary skill in the art readily appreciates that the present invention is applicable outside the food and beverage context, without departing from the scope of the invention (e.g., the objects may instead by a radio, a television, or a cell phone, etc.). Also, although the present invention is illustrated and described in the context of tailgating and football, one of ordinary skill in the art readily appreciates that the present invention is also applicable to other uses, sports, and mascots, without departing from the scope of the invention, such as a use as a stationary furniture piece. Further, although the invention is illustrated as a sports action pose for a quarterback, other sports and other positions could be used instead, such as a running back pivoting to change his direction, a defensive lineman in a three point stance, a cornerback high stepping into the end zone after an interception, etc.

In one embodiment, the device is the ultimate fan accessory for tailgating, fan caves, homes, offices, and college dorms. The device serves as a fun, visible symbol of fan support for their team, while also providing utility as a multi-function holder for food, beverages, and grill utensils.

The sports merchandising market, an 18 billion dollar per year business, has seen nothing like this device. For example, one particular business lists 845 different tailgating products associating with a particular college football team, and not one product even remotely resembles this device. Also, none of the devices existing outside the sporting world making up for the deficiencies, as the device is unlike any conventional tray.

The device is a sports figure in action. The device has a strong structural configuration enabling it to hold heavy objects in a stable manner. The device is also capable of holding multiple objects simultaneously. Additionally, the device is capable of being disassembled after use at a temporary function such as tailgating.

FIG. 2 illustrates a device 200 according to an embodiment of the invention. The device 200 includes a base 205, a body 210, a tray 215, and a cup holder 225. The device 200 (e.g., tray device, sports figure, mascot, etc.) is in a sports action pose. Unlike the conventional device 100, the device 200 provides improved stability, mobility, and storage.

The base 205 provides stability such that the objects do not tip over the device 200. The base 205 may resemble a sports theme and be painted like green AstroTurf with white hash marks. In one embodiment, the base 205 may include a handle (not shown), where the handle may comprise a hole near the middle of one edge of the base 205 which allows the user to insert four fingers and carry the base 205 or the device 200.

The body 210 illustrates a team player in a “sports action pose.” The sports action pose is a sporty position that provides both functional and aesthetic benefits. A functional benefit is the increased stability of the sporty position. Many sports action poses are inherently stable, as stability is a key factor to success in many sports. The body 210 has stability through the legs and arms being spread apart out wide for balance. An aesthetic benefit of the sports action pose is that it brings more life into body 210. In one embodiment, the body 210 is positioned to show the front view of the jersey and the profile view of the head (face and helmet). In one embodiment, the feet of the body 210 snap into the base 205. In another embodiment, a pin is used to secure each foot to the base 210.

The tray 215 is configured to hold objects (not shown). The tray 215 may have sporty curves. In one embodiment, the tray 215 represents the same theme as that of the body 210. In one embodiment, the theme is football. The tray 215 may have a color and shape, which when viewed from above, resembles a football. The tray 215 may be on a raised arm and at shoulder level, such that it looks like the quarterback is throwing the football and the tray 215 may connect with the shoulder of the body 210 for additional stability.

The cup holder 225 provides a structure for holding additional objects. The cup holder can be configured to hold a 12 ounce alcoholic or non-alcoholic drink. The cup holder also further lessens the chances that an object falls or spills, as the cup holder 225 has higher edges than a tray and the walls of the cup holder 225 are configured to fit a beverage, which makes spillage less likely than when the beverage is placed on a tray. This lessened chance of spillage is more important in the sports context, where the user is more likely to be watching television, and less focused on spilling than in the conventional butler context, which likely has less distractions and emotions than that of a sports fanatic during a sporting event. In another embodiment, the device 200 has a bottle opener in the hand which is not holding the tray 215, as opposed to the cup holder 225.

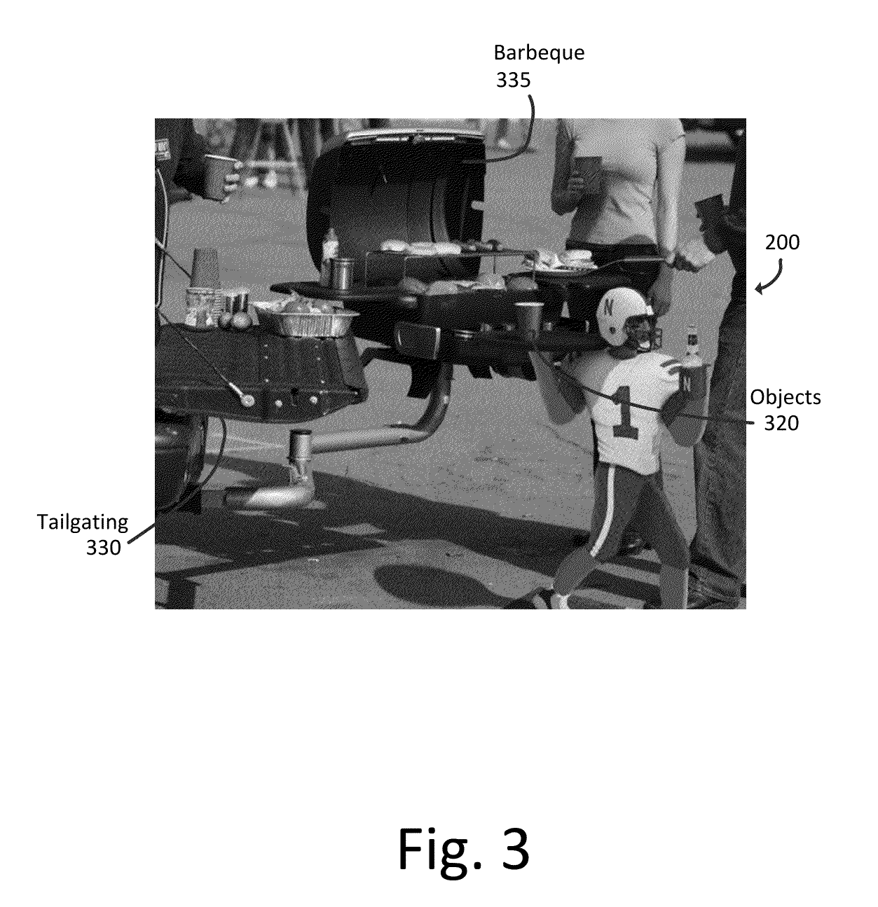

FIG. 3 illustrates the device 200 in use holding one or more objects 320 according to an embodiment of the invention. The objects 320 can include a larger quantity of items and larger sized items due to the increased stability of the device 200. Exemplary objects include foods, beverages, grilling utensils, etc.

The device 200 is shown in the context of tailgating 330, where the user is at a sporting event. The user may have his vehicle's tailgate down and a barbeque out for grilling food. The foldable and disassembly features of the device 200 lead to increased mobility such that the device 200 can be more easily transported to a sporting event.

In one embodiment, the device 200 is 3 feet tall, with a 2 foot wide base, and the non-head portion of the body is 6 inches thick. The height can be configured based on a tailgating height or a coffee table height. The height may be adjustable based on a rod within the body 210.

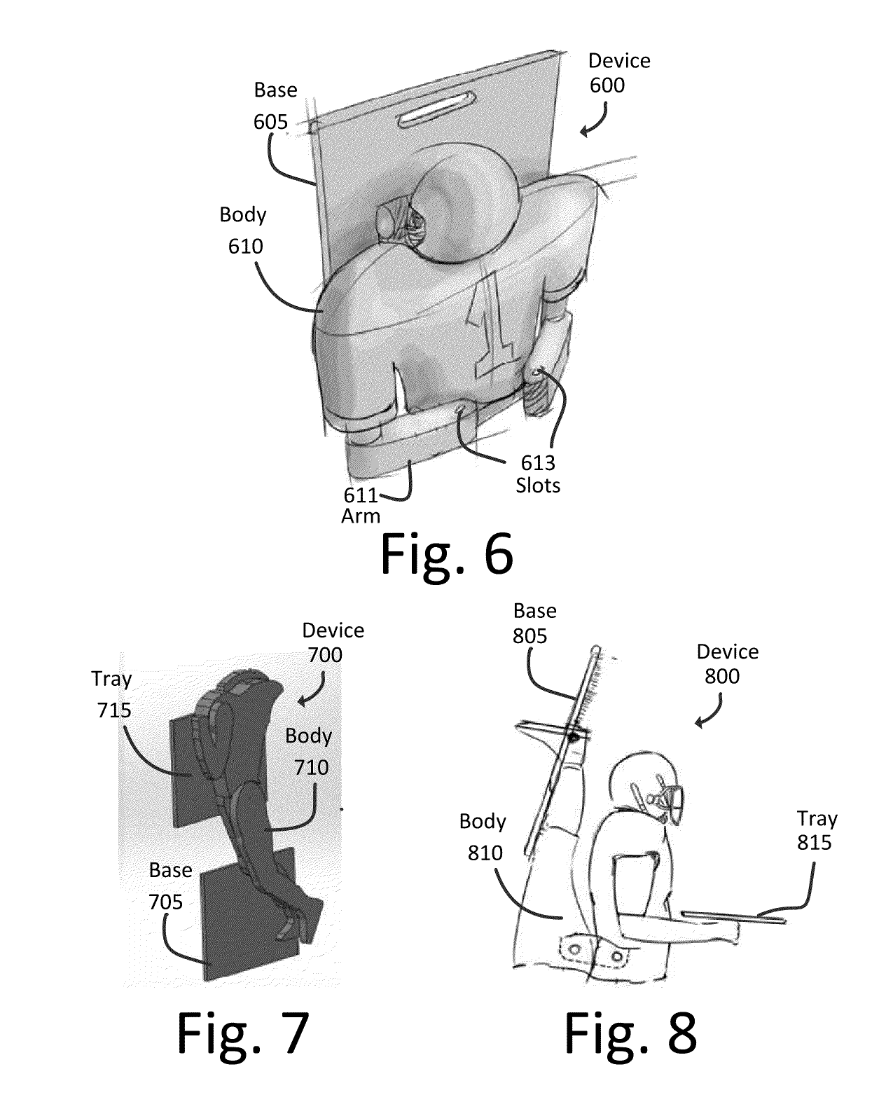

With a 6 inch thickness, the non-head portion of the body 210 is basically flat. Although all devices are technically 3-D, for the purposes of this application, the term 2-dimensional or 2-D refers to this basically flat embodiment, where the flat 2-D embodiments are illustrated in FIGS. 2-5 and FIG. 7. Also, for the purposes of this application, the term 3-dimensional or 3-D refers to a more rounded and thicker embodiment, where the 3-D embodiments are shown in FIGS. 6 and 8.

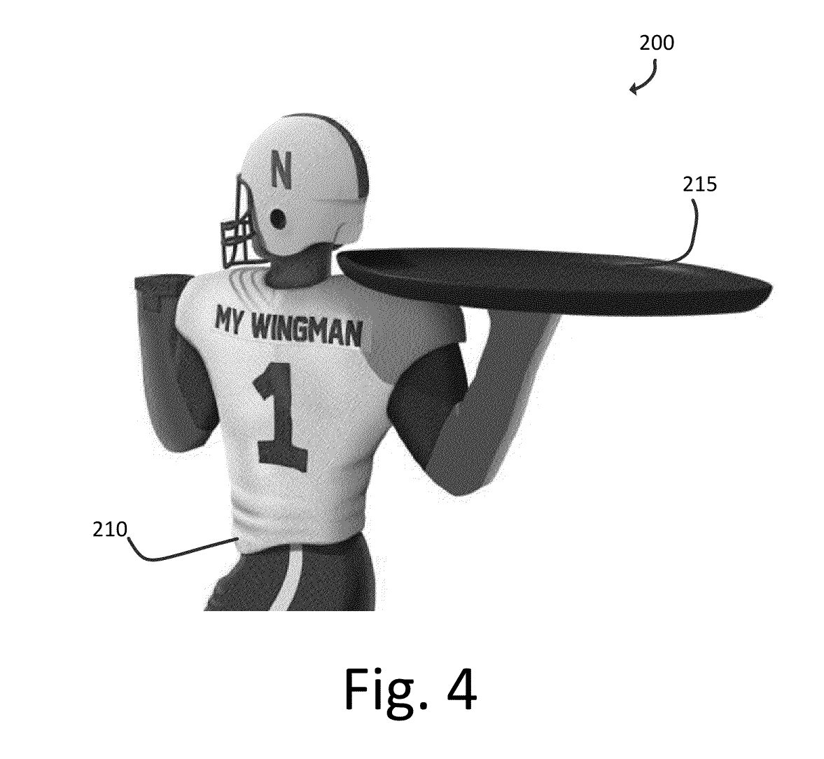

FIG. 4 illustrates a close-up of the tray 215 of the device 200 according to an embodiment of the invention. The close-up illustrates the large size of the tray 215, the top back side of the body 210 being a team player in a sports pose, and the device 200 with the cup holder 225 (not shown) being disassembled.

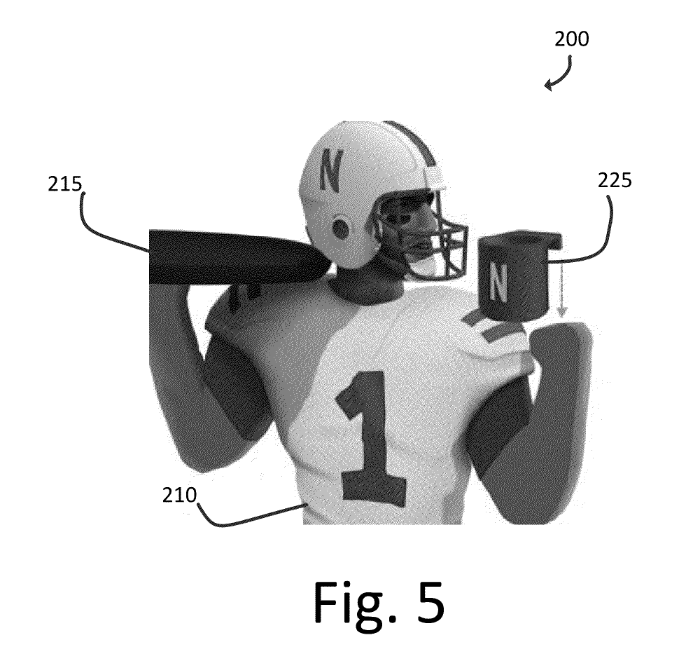

FIG. 5 illustrates a close-up of the cup holder 225 of the device 200 and optional assembly features according to an embodiment of the invention. The close-up illustrates the top front side of the body 210 being a team player in a sports pose. The head (face and helmet) are 3-D, and can be made from molded resin and painted. The head can be painted using techniques such as shadows to bring further life to the body 210.

The close-up also illustrates the cup holder 225 just prior to being assembled onto the device 200. The cup holder 225 can slide onto the arm of the body 210 or can be screw mounted on. In one embodiment, the device 200 uses the same mounting screws for the base 205, the tray 215, and the cup holder 225.

In one embodiment, the device 200 is considered to have three main parts: the base 205, the body 210, and the tray 215. In this embodiment, each part can be disassembled from each other and reassembled back together for improved mobility and storage. In another embodiment, the device 200 is considered to have five main parts: the base 205, the tray 215, a front body plane of the body 210, a back body plane of the body 210, and a head of the body 210.

In a preferred embodiment, for transportation, the device 200 is disassembled into four pieces: the base 205, the body 210, the tray 215, and the cup holder 225. In another embodiment, the device is folded instead of disassembled.

FIGS. 6-8 illustrate devices 600, 700, and 800 with optional folding features according to embodiments of the invention. The bodies of devices 600 and 800 are illustrated as being 3-dimensional, whereas the body of the device 700 is illustrated as being 2-dimensional. As mentioned above, for the purposes of this application, the term 2-D refers to this basically flat non-head portion of the body embodiment and the term 3-D refers to a more rounded and thicker body embodiment.

FIG. 6 illustrates the device 600 in a folded position. The device 600 includes a base 605, a body 610, with each arm 611 of the body 610 having a slot 613. The base 605 is rotated, rolled up towards the head of the body 610, and folded against the body 610. The body 610 is 3-D. The arms 611 are also folded against the body 610, and a tray (not shown) which is disassembled from the slots 613.

FIG. 7 illustrates the device 700 in a folded position. The device 700 includes a base 705, a body 710, and a tray 715. The base 705 and tray 715 are folded against the body 710. The non-head portion of the body 710 is 2-D. The head (not shown) is 3-D.

FIG. 8 illustrates the device 800 in a folded position. The device 800 includes a base 805, a body 810, and a tray 815. The body 810 is folded and the base 805 is rotated against the body 810. The body 810 is 3-D. The tray 815 is configured to be removed from the body 810.

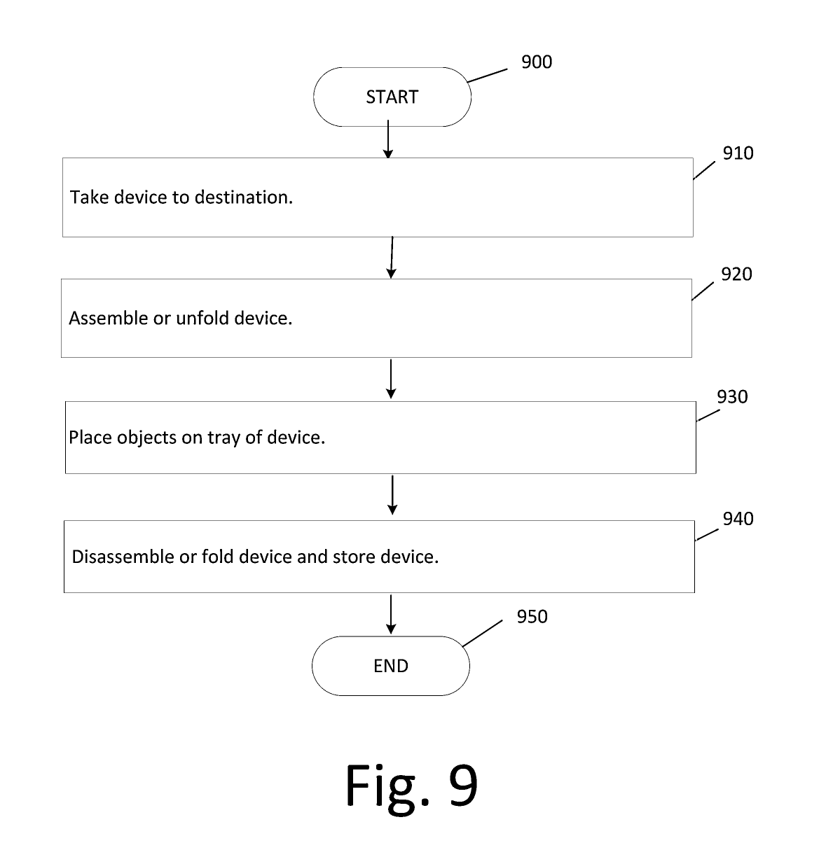

FIG. 9 illustrates a process of using the device 200 according to an embodiment of the invention. The process starts at step 900. At step 910, a user takes the device 200 to a destination. The destination can be a tailgating party, a position next to a television during a sports event, a fixed location such as stationary furniture piece in a house or restaurant, etc. At step 920, the user assembles or unfolds the device 200. The device 200 provides mobility, with the 2-D body, the folding, and/or disassembly allowing it to be easily carried to a sporty location, shipped, or put into the trunk and transported to a sporting event.

At step 930, the user places the objects 320 on the tray 215 of the device 200. The objects 320 can include food, drinks, or anything else configured to be placed on a tray. The device 200 provides increased stability due to the action pose that the body 210 is positioned in. At step 940, the user disassembles or folds the device 200 and stores the device 200 away. The ability to either fold or dissemble the device 200 allows for easier storage. The process may be repeated recursively a number of times and ends at step 950.

It is to be recognized that depending on the embodiment, certain acts or events of any of the methods described herein can be performed in a different sequence, may be added, merged, or left out altogether (for example, not all described acts or events are necessary for the practice of the method). Moreover, in certain embodiments, acts or events may be performed concurrently, rather than sequentially.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

What is claimed is:

1. A device comprising:
a body, wherein the body is configured in a sports action pose, wherein the sports action pose comprises an action relating to a sport;
a tray attached to the body, wherein the tray is configured to hold objects; and
a base attached to the body, wherein the base and the sports action pose of the body are configured to provide stability to the body.

2. The device of claim 1 further comprising a cup holder.

3. The device of claim 1, wherein body comprises a plurality of legs, wherein the legs are spread apart and configured for balance.

4. The device of claim 1, wherein body resembles a sports theme.

5. The device of claim 1, wherein the tray resembles a sports theme.

6. The device of claim 1, wherein base resembles a sports theme.

7. The device of claim 1, wherein the body comprises a head and a non-head portion.

8. The device of claim 7, wherein the non-head portion is 2-dimensional.

9. The device of claim 7, wherein the non-head portion is 3-dimensional.

10. The device of claim 7, wherein the head is 3-dimensional.

11. The device of claim 1, wherein the body, tray, and base are configured to be disassembled from each other.

12. The device of claim 1, wherein the body, tray, and base are configured to be folded.

13. The device of claim 1, wherein the objects comprise a food, a beverage, or a grill utensil.

14. The device of claim 1, wherein the base comprises a handle.

15. The device of claim 1, wherein body comprises a mascot, wherein the mascot includes all sports mascots.

16. The device of claim 1, wherein the sport includes all sports.

17. The device of claim 16, wherein the sport is football.

18. The device of claim 16, wherein the sport is not football.

19. A device comprising:
a body, wherein the body is configured in a sports action pose, wherein the sports action pose comprises an action relating to a sport;
wherein the body is configured to attach to a tray, wherein the tray is configured to hold objects; and
wherein the body is configured to attach to a base, wherein the base and the sports action pose of the body are configured to provide stability to the body.
